(19) United States
(12) Patent Application Publication
(10) Pub. No.: US 2008/0209122 A1
(43) Pub. Date: Aug. 28, 2008

(54) Method of automatically adjusting size of copy-on-write disk space of snapshot device

(75) Inventors: Lei Li, Tianjin (CN); Jian-Feng Guo, Tianjin (CN); Tom Chen, Taipei (TW); Win-Harn Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/710,524

(22) Filed: Feb. 26, 2007

(51) Int. Cl. G06F 13/00

(52) U.S. Cl. 711/112

(57) ABSTRACT

A method of automatically adjusting a size of a copy-on-write (COW) disk space of a snapshot device is provided. A first disk space of a snapshot device is initialized, and a COW operation is performed on a chunk of the first disk space. Next, it is determined whether a chunk sequence number of a write request is in the first disk space. Then, if the chuck sequence number of the write request is in the first disk space, the first disk space is maintained. Then, if the chuck sequence number of the write request is not in the first disk space, a second disk space is initialized, and the number of chunks of the second disk space is the same as the number of maximum successive chunks of the first disk space, and then, the COW operation is performed on the chunk of the second disk space.

### BACKGROUND OF THE INVENTION

1. Field of Invention

The present invention relates to a storage system management method. More particularly, the present invention relates to a snapshot device management method of a storage system.

2. Related Art

Logical volume management (LVM) based on Linux system is realized by adding one additional layer in an input/output (I/O) subsystem, and this layer added between a file system and a physical disk driver is called a logical volume device driver (LVDD). Through the LVDD, the upper file system or other applications obtain a disk or partition virtual view. Referring to FIG. 1, the LVM configures physical volumes (PV) 120 composed of a plurality of physical extents (PE) 140 on a plurality of the same type of storage devices (e.g., hard disk and RAID device), and groups the PVs 120 to a volume group (VG) 100 by way of connecting them in series or striping. After the VG 100 is divided into one or more logical volumes (LV), the /device/vg-name/lv-name is used to access the LV, similar to using the /disk/partition. The LVM can dynamically modify the size of the storage space, without rebooting the computer system, and the data will not be lost.

In order to ensure the data security, the LVM adopts a snapshot mechanism. The snapshot technology is a backup mode for block devices such as hard disks and logic disks. The device activating the snapshot is called an original block device, and the activated snapshot is a block device relevant to the original block device, which is called a snapshot device. Description structures of both the original block device and the snapshot device are saved in a system random-access memory (RAM), and the snapshot device itself also needs a certain physical storage space. Usually, when the snapshot is activated, the original block device, the actual capacity of the snapshot, and the storage device used by the snapshot device itself need to be designated, and the logic storage capacity of the snapshot device is the size of the original block device. The minimum unit of data storage and space division on the snapshot device is a chunk, which usually has a size of 64 k.

The snapshot is not a total backup of the data stored in the original block device, but divides the original block device into chunks, and till it requires modifying the data of the original block device, the data in the chunk required to be modified is copied to the snapshot device, and this technology is called copy-on-write (COW) technology.

Once the snapshot is activated, it is divided into a plurality of PEs (usually taking M as the unit), and each PE is divided into a plurality of chunks. A first chunk of each PE is used to record the corresponding relationship (i.e., the exception table) between an old chunk and a new chunk, and the remaining chunks are used to store the COW data.

Referring to FIG. 2, once the computer system is booted, the system kernel reads the exception table on the hard disk, so as to set up a hash table on the memory. When the write request sent by the subscriber is received (step 200), and the COW operation is required, it is firstly determined whether the snapshot corresponding to the chunk of the write request exists or not (step 202). If the snapshot does not exist, it continues to send the write request (step 210), otherwise, the hash table in the memory is traversed (step 204), and it is determined whether a corresponding item is found from the hash table or not (step 206). If the corresponding item is found in the hash table, it indicates that the COW operation for the chunk of the write request has been finished, so it continues to send the write request (step 210), otherwise, the COW operation is performed (step 208), and then, it continues to send the write request (step 210).

Main disadvantages of the conventional art are described as follows.

1. Each time when the chunk is required to be modified, a COW operation is performed once. The COW operation adopts a synchronous I/O operation, that is to say, it has to wait until the write operation is finished, so as to perform the subsequent operation. Therefore, when a great number of write requests occurs, the COW mechanism may cause a great number of I/O operations, which may significantly reduce the system performance.

2. Once the snapshot is activated, the size of the chunk cannot be changed. If the chunk is set to be too small, when the write request with a large capacity is processed, a great number of I/O operations are resulted, which greatly reduces the system performance. On the contrary, if the chunk is set to be excessively large, when the write request with a small capacity is processed, the disk space is wasted, and thus, the processing speed of the system is lowered.

### SUMMARY OF THE INVENTION

In order to solve problems and disadvantages in the conventional art, the present invention is directed to a method of automatically adjusting a size of the COW disk space of the snapshot device.

The present invention provides a method of automatically adjusting the size of the COW disk space of the snapshot device, which comprises the following steps:

a) initializing a first disk space of a snapshot device, and performing a COW operation on a chunk of the first disk space;

b) determining whether a chunk sequence number of a write request is in the first disk space or not;

c) if yes, continuing to maintain the first disk space; and

d) if not, initializing a second disk space, wherein the number of chunks of the second disk space is the same as the number of the maximum successive chunks of the first disk space, and then performing the COW operation on the chunk of the second disk space.

The data structure of the first disk space comprises an original sequence number data variable, a current original sequence number data variable, a current last sequence number data variable, a current maximum data variable, and a maximum data variable.

The initial value of the original sequence number of the first disk space is 0, the initial value of the current original sequence number is 0, the initial value of the current last sequence number is 0, the initial value of the current maximum number is 1, and the initial value of the maximum number is 1.

The step b) further comprises: obtaining a result of adding the value of the original sequence number of the first disk space to the value of the maximum number; and determining whether the chunk sequence number of the write request is larger than this result.

The step c) further comprises: determining whether or not the chunk sequence number of the write request is equal to the value of the current last sequence number of the first disk space plus 1; if yes, adding 1 to the value of the current last sequence number of the first disk space; if not, obtaining a result of subtracting the value of the current original sequence number of the first disk space from the value of the current last sequence number, assigning the larger one of the result and the value of the current maximum number of the first disk space to the current maximum number of the first disk space, and assigning the chunk sequence number of the write request to the current original sequence number and the current last sequence number of the first disk space.

The data structure of the second disk space is the same as that of the first disk space.

The step d) further comprises: determining whether or not the chunk sequence number of the write request is equal to the value of the current last sequence number of the first disk space plus 1; if yes, adding 1 to the value of the current last sequence number of the first disk space, and performing the COW operation on the chunk corresponding to the value of the current last sequence number of the first disk space; if not, assigning the chunk sequence number of the write request to an original sequence number, a current original sequence number, and a current last sequence number of a second disk space, obtaining a result of subtracting the value of the current original sequence number of the first disk space from the value of the current last sequence number, assigning the larger one of the result and the value of the current maximum number of the first disk space to a maximum number of the second disk space, and performing the COW operation on the chunks with the same number as the value of the maximum number of the second disk space, beginning from the chunk corresponding to the value of the original sequence number of the second disk space.

To sum up, the present invention can automatically adjust the size of the COW disk space, and can finish many successive COW operations at one time, which greatly enhances the system performance through the successive, concentrated, and sudden request.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a block diagram of a structure of a VG in the conventional art;

FIG. 2 is a flow chart of a snapshot processing of a write request in the conventional art;

FIGS. 3 and 4 are flow charts of a method of automatically adjusting a size of a COW disk space of a snapshot device according to the present invention; and

FIG. 5 is a block diagram of states of a first disk space at different time points.

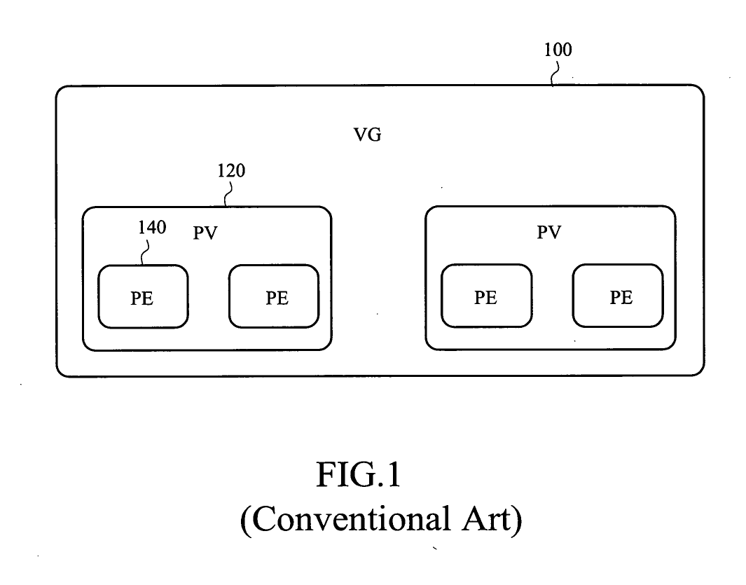

### DETAILED DESCRIPTION OF THE INVENTION

The preferred embodiment of the present invention is illustrated in detail below with reference to the drawings.

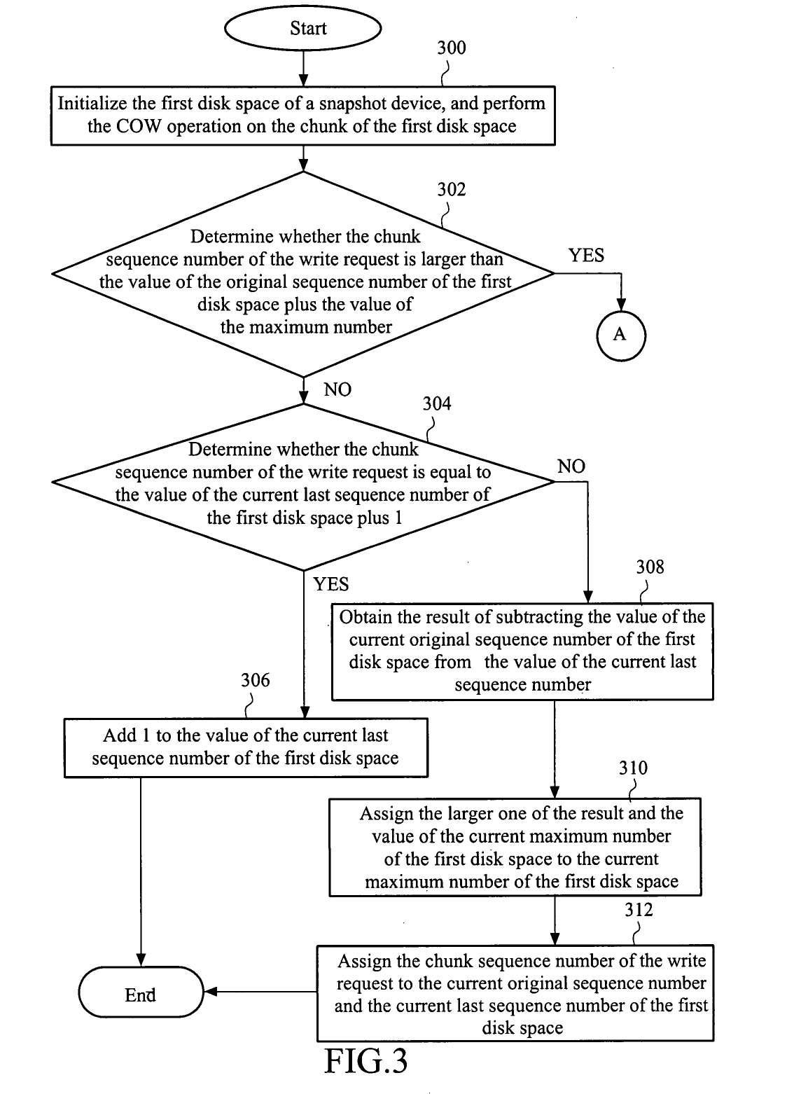

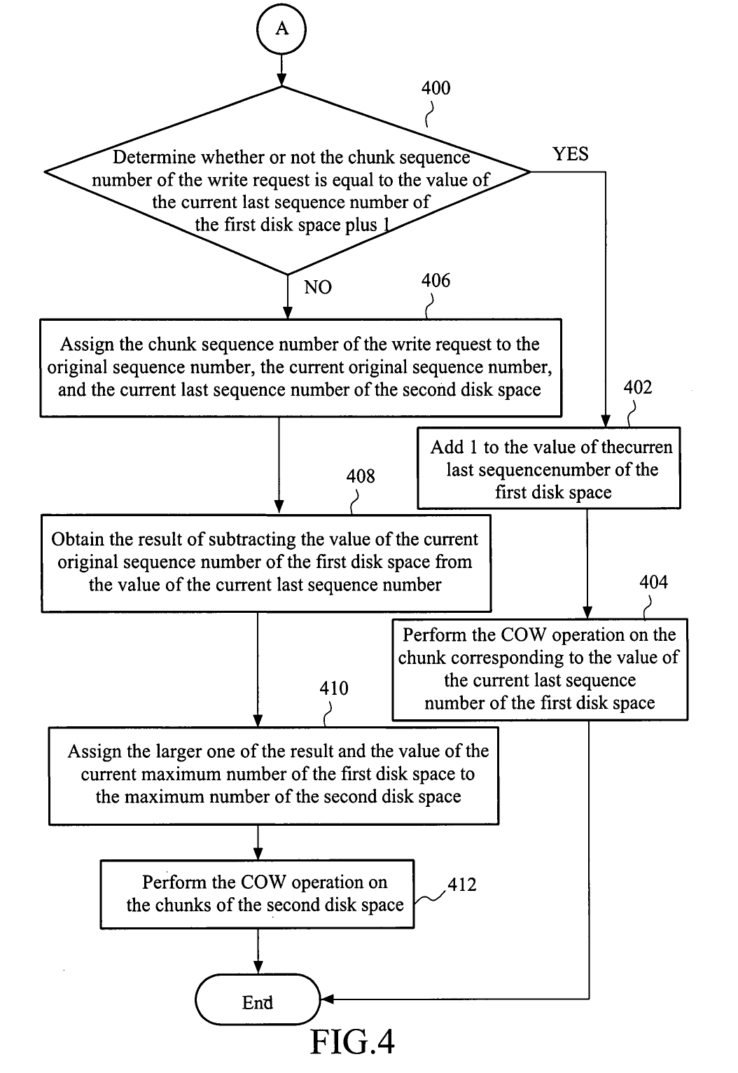

FIGS. 3 and 4 show a method of automatically adjusting a size of a COW disk space of a snapshot device according to the present invention. Letter A indicates the processing flow when the chunk sequence number of the write request is larger than the value of the original sequence number of the first disk space plus the value of the maximum number.

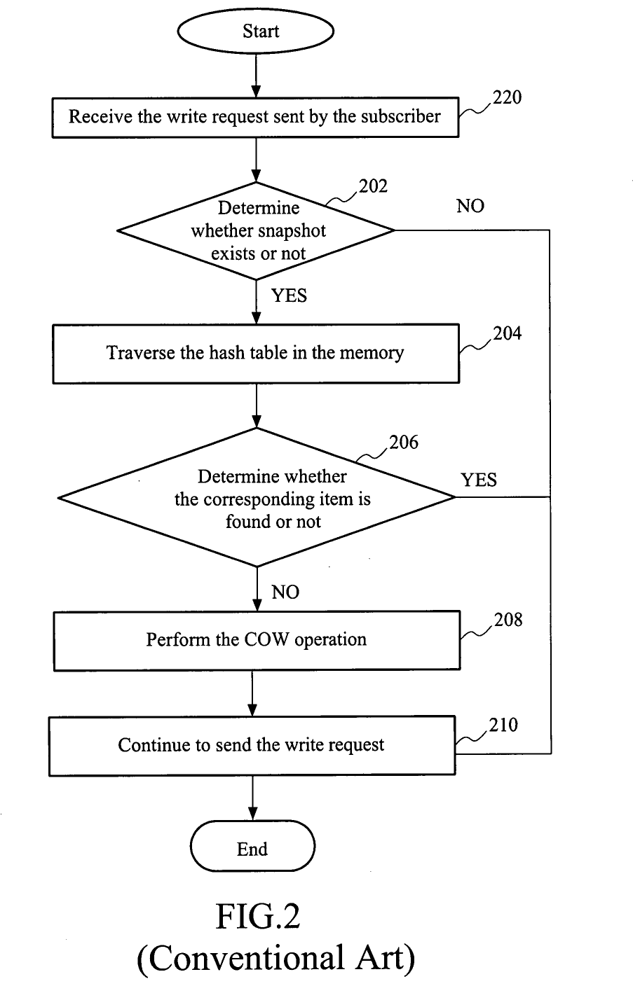

As shown in FIG. 2, in the snapshot processing flow of the write request in the conventional art, if no message corresponding to the chunk of the write request exists in the hash table, and the COW operation is required to be performed (step 208), the present invention may be used to replace the conventional processing mode.

Firstly, a first disk space of a snapshot device is initialized, and the COW operation is performed on the first disk space (step 300). The data structure of the initialized first disk space includes an original sequence number data variable, a current original sequence number data variable, a current last sequence number data variable, a current maximum data variable, and a maximum data variable. For example, a structure described below is adopted.

#typedef struct cow_writea
{

Int64 org_window_chunk;
Int tmp_window_org_chunk;
Int tmp_window_last_chunk;
Int tmp_max_windows;
Int last_windows_chunks;

}last_cow_writea;

The original sequence number data variable (org_window_chunk) is used to indicate the first chunk sequence number of the first disk space, and the initial value is 0. The current original sequence number data variable (tmp_window_org_chunk) is used to indicate the first chunk sequence number of the successive chunks being maintained in the first disk space, and the initial value is 0. The current last sequence number data variable (tmp_window_last_chunk) is used to indicate the last chunk sequence number of the successive chunks being maintained, i.e., the chunk sequence number of the previous write request, and the initial value is 0. The current maximum data variable (tmp_max_windows) is used to indicate the current maximum number of successive chunks in the first disk space, and the initial value is 1. The maximum data variable (last_windows_chunks) is used to indicate the maximum number of successive chunks in the previous disk space, and the initial value is 1, and the maximum chunk sequence number maintained in the first disk space can be obtained by adding the maximum data variable to the value of the original sequence number.

Once the write request sent by the subscriber is received, and the COW operation needs to be performed, it is determined whether the chunk sequence number of the write request is in the first disk space or not, that is, the result of adding the value of the original sequence number of the first disk space to the maximum number is obtained, and then, it is determined whether the chunk sequence number of the write request is larger than the result or not (step 302). In other words, the number of chunks of the write request is not larger than a maximum input and output value of the disk defined by an operation system of the snapshot device.

If the chunk sequence number of the write request is smaller than or equal to the result of adding up the two, it indicates that the chunk sequence number of the write request is in the first disk space. At this time, it continues to determine whether or not the chunk sequence number of the write request is equal to the value of the current last sequence number of the first disk space plus 1 (step 304), that is, it is determined whether the chunk sequence number of the write request is successive with the successive chunks being maintained currently.

If the chunk sequence number of the write request is equal to the value of the current last sequence number of the first disk space plus 1, it indicates that the chunk sequence number of the write request is successive with the successive chunks being maintained in the first disk space. The first disk space has already finished the COW operation when it is initialized, so it only needs to add 1 to the value of the current last sequence number of the first disk space (step 306).

If the chunk sequence number of the write request is not equal to the value of the current last sequence number of the first disk space plus 1, it indicates that the chunk sequence number of the write request is not successive with the successive chunks being maintained in the first disk space. Therefore, the result of subtracting the value of the current original sequence number of the first disk space from the value of the current last sequence number is obtained (step 308), and the larger one of the result and the value of the current maximum number of the first disk space is assigned to the current maximum number of the first disk space (step 310), so as to update the current maximum number of successive chunks stored in the current maximum number of the first disk space. Then, the chunk sequence number of the write request is assigned to the current original sequence number and the current last sequence number of the first disk space (step 312), so as to activate another successive chunk area in the first disk space.

If the chunk sequence number of the write request is larger than the result of adding the value of the original sequence number of the first disk space to the value of the maximum number, it indicates that the chunk sequence number of the write request is not in the first disk space. At this time, it continues to determine whether or not the chunk sequence number of the write request is equal to the value of the current last sequence number of the first disk space plus 1 (step 400), that is, it is determined whether the chunk sequence number of the write request is successive with the successive chunks being maintained currently.

If the chunk sequence number of the write request is equal to the value of the current last sequence number of the first disk space plus 1, it indicates that the chunk sequence number of the write request is successive with the successive chunks being maintained in the first disk space. However, the chunk sequence number of the write request is not in the first disk space, that is, the COW operation has not performed to the chunk of the write request yet. Thus, firstly, 1 is added to the value of the current last sequence number of the first disk space (step 402). Then, the COW operation is performed on the chunk corresponding to the value of the current last sequence number of the first disk space (step 404), so as to extend the capacity of the first disk space.

If the chunk sequence number of the write request is not equal to the value of the current last sequence number of the first disk space plus 1, it indicates that the chunk sequence number of the write request is not successive with the successive chunks being maintained in the first disk space, so it requires to initialize a second disk space. The data structure of the second disk space is the same as that of the first disk space, and the number of chunks of the second disk space when it is initialized is the number of the maximum successive chunks of the first disk space. During the process of initializing the second disk space, firstly, the chunk sequence number of the write request is assigned to the original sequence number, the current original sequence number, and the current last sequence number of the second disk space (step 406). Next, the result of subtracting the value of the current original sequence number of the first disk space from the value of the current last sequence number is obtained (step 408), and the larger one of the result and the value of the current maximum number of the firs disk space is assigned to the maximum number of the second disk space (step 410). Finally, the COW operation is performed on the chunks with the same number as the maximum number of the second disk space, beginning from the chunk corresponding to the value of the original sequence number of the second disk space (step 412).

As known from the above, if the chunk sequence number of the write request is not in the first disk space, but equal to the value of the last sequence number of the first disk space plus 1, the size of the first disk space can be automatically adjusted. The COW operations for all the chunks of the first disk space and the second disk space are finished at one time, so as to extremely enhance the system performance through the successive, concentrated, and sudden request.

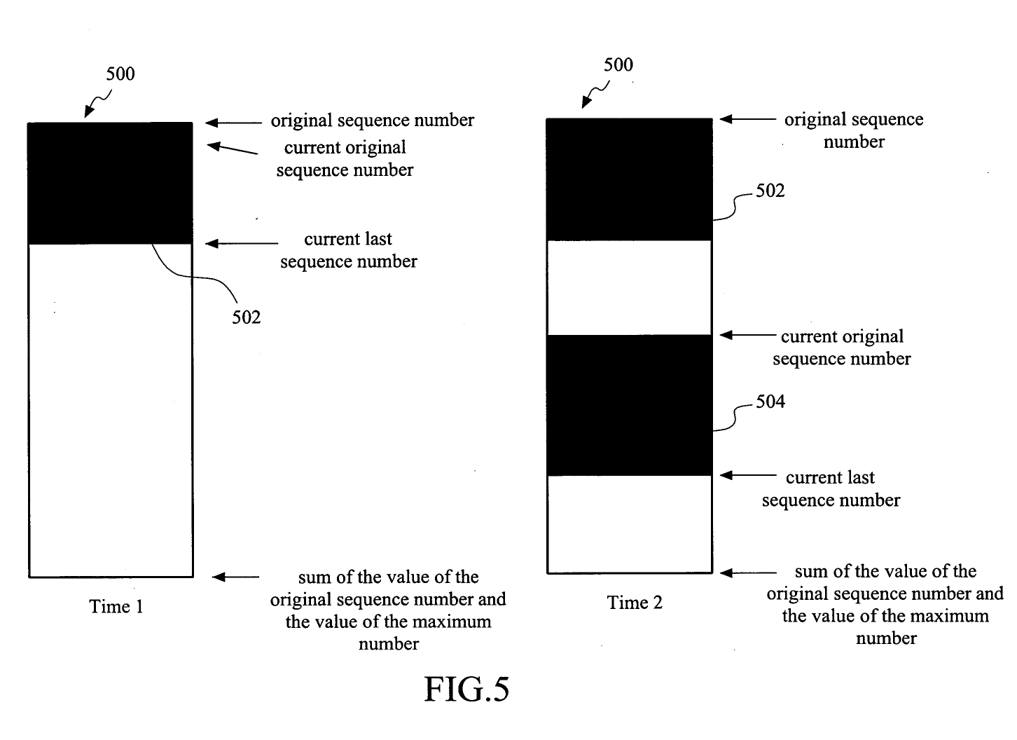

Referring to FIG. 5, it is a block diagram of states of the first disk space 500 at different time points. As for the initialized first disk space 500, the original sequence number, the current original sequence number, and the current last sequence number are the same value, i.e., the sequence number of the first chunk in the first disk space 500. The value of the current maximum number is the initial value 1, and the value of the maximum number is also the initial value 1, i.e., the first disk space 500 only includes one chunk.

The first disk space 500 at time 1 includes a first successive chunk area 502. At this time, the value of the original sequence number of the first disk space 500 does not change, and the value of the current original sequence number is the sequence number of the first chunk in the first successive chunk area 502, and the value of the current last sequence number is the sequence number of the last chunk in the first successive chunk area 502, i.e., the chunk sequence number of the previous write request. The value of the current maximum number is still the initial value 1.

The first disk space 500 at time 2 includes two successive chunk areas, the first successive chunk area 502 and the second successive chunk area 504. The value of the original sequence number of the first disk space 500 still does not change, and it is the sequence number of the first chunk in the first disk space 500. The value of the current original sequence number is changed to be the sequence number of the first chunk in the second successive chunk area 504, the value of the current last sequence number is changed to be the sequence number of the last chunk in the second successive chunk area 504, and the value of the current maximum number is the number of chunks of the first successive chunk area 502.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of automatically adjusting a size of a copy-on-write (COW) disk space of a snapshot device, comprising:
a) initializing a first disk space of the snapshot device, and performing a COW operation on a chunk of the first disk space;
b) determining whether a chunk sequence number of a write request is in the first disk space or not;
c) if yes, continuing to maintain the first disk space; and
d) if not, initializing a second disk space, wherein number of chunks of the second disk space is same as number of maximum successive chunks of the first disk space, and then, performing the COW operation on the chunk of the second disk space.

2. The method of automatically adjusting a size of a COW disk space of a snapshot device as claimed in claim 1, wherein number of chunks of the write request is not larger than a maximum input and output value of a disk defined by an operation system of the snapshot device.

3. The method of automatically adjusting a size of a COW disk space of a snapshot device as claimed in claim 1, wherein data structure of the first disk space comprises an original sequence number data variable, a current original sequence number data variable, a current last sequence number data variable, a current maximum data variable, and a maximum data variable.

4. The method of automatically adjusting a size of a COW disk space of a snapshot device as claimed in claim 3, wherein an initial value of the original sequence number data variable of the first disk space is 0, an initial value of the current original sequence number data variable is 0, an initial value of the current last sequence number data variable is 0, an initial value of the current maximum data variable is 1, and an initial value of the maximum data variable is 1.

5. The method of automatically adjusting a size of a COW disk space of a snapshot device as claimed in claim 3, wherein the step b) further comprises:
obtaining a result of adding value of the original sequence number data variable of the first disk space to value of the maximum data variable; and
determining whether the chunk sequence number of the write request is larger than the result.

6. The method of automatically adjusting a size of a COW disk space of a snapshot device as claimed in claim 3, wherein the step c) further comprises:
determining whether or not the chunk sequence number of the write request is equal to value of the current last sequence number data variable of the first disk space plus 1;
if yes, adding 1 to the value of the current last sequence number data variable of the first disk space; and
if not, obtaining a result of subtracting value of the current original sequence number data variable of the first disk space from the value of the current last sequence number data variable, assigning larger one of the result and value of the current maximum data variable of the first disk space to the current maximum data variable of the first disk space, and assigning the chunk sequence number of the write request to the current original sequence number data variable and the current last sequence number data variable of the first disk space.

7. The method of automatically adjusting a size of a COW disk space of a snapshot device as claimed in claim 3, wherein data structure of the second disk space is same as that of the first disk space.

8. The method of automatically adjusting a size of the COW disk space of the snapshot device as claimed in claim 7, wherein the step d) further comprises:
determining whether or not the chunk sequence number of the write request is equal to value of the current last sequence number data variable of the first disk space plus 1;
if yes, adding 1 to the value of the current last sequence number data variable of the first disk space, and then, performing the COW operation on a chunk corresponding to the value of the current last sequence number data variable of the first disk space;
if not, assigning the chunk sequence number of the write request to an original sequence number data variable, a current original sequence number data variable, and a current last sequence number data variable of the second disk space, obtaining a result of subtracting value of the current original sequence number data variable of the first disk space from value of the current last sequence number data variable, and assigning larger one of the result and value of the current maximum data variable of the first disk space to a maximum data variable of the second disk space; and
performing the COW operation on chunks with same number as value of the maximum data variable of the second disk space, beginning from a chunk corresponding to value of the original sequence number data variable of the second disk space.
